(19) United States
(12) Patent Application Publication
(10) Pub. No.: US 2020/0023415 A1
(43) Pub. Date: Jan. 23, 2020

(54) AUTOMATIC CLEANING AND SPRAYING DEVICE

(71) Applicant: ADVANFLO TECHNOLOGIES CO., LTD., New Taipei City (TW)

(72) Inventor: CHUN-MING LAI, New Taipei City (TW)

(73) Assignee: ADVANFLO TECHNOLOGIES CO., LTD., New Taipei City (TW)

(21) Appl. No.: 16/040,560

(22) Filed: Jul. 20, 2018

(51) Int. Cl. B08B 17/02; B08B 3/08; B08B 3/02

(52) U.S. Cl. CPC B08B 17/02; B08B 3/02; B08B 3/08

(57) ABSTRACT

An automatic cleaning and spraying device includes a mixer connected in series with a gas pipeline of the spraying device. A cleaning liquid (such as a solvent) introduced by the mixer is guided to a controlled cleaning liquid valve installed at the front end of the cleaning liquid pipeline, so that the cleaning liquid can be mixed with a gas, and then the mixed liquid and gas flow towards a spray valve and an atomizer. During a normal spray operation, only the pressurized gas valve and spray valve are turned on for the actual spray operation. After a specific period of operation, the cleaning liquid valve may be controlled automatically to input the cleaning liquid to the mixer and then to the spray valve and atomizer in order to clean the surrounding and inner wall of the spray outlet and achieve the effect of cleaning the spraying device automatically.

### BACKGROUND OF THE INVENTION

### Field of the Invention

The present invention relates to a spraying device, in particular to an automatic cleaning and spraying device which is a two-fluid atomization spraying device having an automatic cleaning device and capable of cleaning the residue around a nozzle of the spraying device automatically.

### Description of Related Art

With reference to FIG. 1 for a conventional two-fluid atomization spray, the two-fluid atomization spray comprises: a spray valve 10, a gas pipeline 20 coupled to the spray valve 10, a gas valve 30 installed in the gas pipeline 20, and a liquid inlet 101 disposed on the other side of the spray valve 10. The gas pipeline 20 is provided for inputting a high-pressure gas (such as air) into the spray valve 10, and the high-pressure gas in the spray valve 10 is mixed with a liquid inputted from the liquid inlet 101, and then the mixed high-pressure gas and liquid are sprayed in a misty form by high pressure from an outlet 102 of the spray valve 10, so as to achieve the operation of spraying an object surface, such as the operation of spraying an LED packaging material or an electromagnetic shielding material, etc.

In the spraying process carried out by the aforementioned two-fluid atomization device, a gas flows quickly through the outlet 102 of the spray valve 10, so that a residual liquid material is often accumulated around the outlet 102 of the spray valve 10, and the inner wall of the spray valve 10 is turned into a barrier and finally solidified to form a blockage that is difficult to remove and directly affects the flow and uniformity of the subsequent spray. In addition, the blockage of this sort may be accumulated inside or outside the outlet 102 of the spray valve 10, and may finally clog the whole spray valve 10 and outlet 102 if the blockage is not removed from time to time.

To overcome the aforementioned drawbacks, the spray valve is usually cleaned manually, or a brush and a cleaning liquid are used for cleaning, or the spray valve is soaked into a liquid for cleaning However, these conventional methods can just remove the blockage around the outlet of the spray valve, but still cannot completely remove the blockage from the inner wall of the outlet. In addition, the manual cleaning method is labor intensive and very inefficient. Unskillful persons may directly lead to poor cleaning results, and these methods are not suitable for present automated spraying devices and systems. Therefore, it is a main subject for the present invention to overcome the drawbacks of the aforementioned cleaning methods.

### SUMMARY OF THE INVENTION

In view of the aforementioned drawbacks of the prior art, the inventor of the present invention based on years of experience in the related industry to conduct extensive research and experiment, and finally developed an automatic cleaning and spraying device to achieve the expected effects of the device.

Therefore, it is a primary objective of the present invention to provide an automatic cleaning and spraying device comprising a mixer serially connected to a gas pipeline and provided for introducing a cleaning liquid (such as a solvent) into a controlled cleaning liquid valve disposed at the front end of a cleaning liquid pipeline. During a normal spray operation, only the pressurized gas valve and spray valve are turned on for the actual spray operation. After a certain operating period, the cleaning liquid valve is controlled automatically to input the cleaning liquid into the mixer and then into the spray valve and the atomizer to clean the outlet and inner wall of the spray valve and the atomizer, so as to achieve effect of automatically cleaning the spraying device.

To achieve the aforementioned and other objectives, the present invention provides an automatic cleaning and spraying device comprising: a spray valve, being a device for controlling the supply of a liquid material; an atomizer, combined with an outlet of the spray valve, and having a spray outlet disposed at an end of the atomizer for mixing a pressurized gas with the liquid material supplied by the spray valve and spraying the mixed pressurized gas and liquid material in a misty form; a pressurized gas valve, coupled to the atomizer through a gas pipeline, for controlling the pressurized gas to be outputted to the atomizer; a mixer, installed in a gas pipeline between the atomizer and the pressurized gas valve, for mixing a cleaning liquid with the pressurized gas and then sending the mixed cleaning liquid and pressurized gas to the atomizer; and a cleaning liquid valve, coupled to the mixer through a cleaning liquid pipeline, for controlling the cleaning liquid to be inputted to the mixer.

In the automatic cleaning and spraying device, the spray valve has a liquid inlet coupled to a liquid pipeline; and the atomizer has a gas inlet coupled to the gas pipeline.

In the automatic cleaning and spraying device, the atomizer has a mixing chamber formed inside the spray outlet, and the pressurized gas and the liquid material are mixed after entering into the mixing chamber, and the mixed pressurized gas and liquid material are sprayed in a misty form from the spray outlet to the outside.

In the automatic cleaning and spraying device, the pressurized gas valve and the cleaning liquid valve are valves provided for switching a control by an instruction.

The automatic cleaning and spraying device of the present invention achieves the automatic cleaning effect and the following two cleaning modes are used:

1. When the pressurized gas valve and the cleaning liquid valve are opened, the spray valve remains closed. Now, the pressurized gas mixed with the cleaning liquid are sprayed to the spray valve to dissolve and carry away the residue flowing through the passage, and then sprayed to the outside from the spray outlet of the atomizer

2. When the pressurized gas valve is not opened (but closed), only the cleaning liquid valve is opened, and the spray valve remains closed. Therefore, the cleaning liquid flows through the spray valve to dissolve the residue and carry away the residue to the outside from the spray outlet of the atomizer

### BRIEF DESCRIPTION OF THE DRAWINGS

FIG. 1 is a cross-sectional view of a conventional spray valve without an automatic cleaning device;

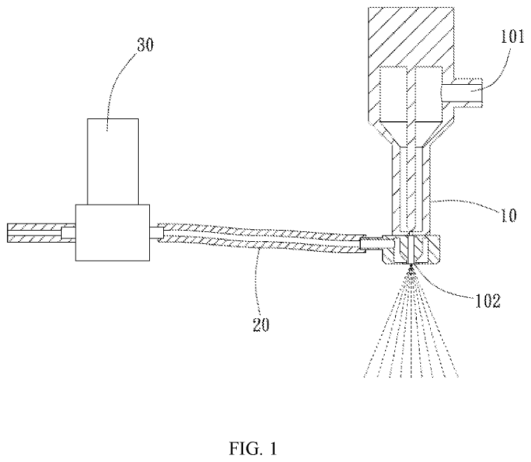

FIG. 2 is a perspective view of an automatic cleaning and spraying device in accordance with a preferred embodiment of the present invention; and

FIG. 3 is a cross-sectional view of an automatic cleaning and spraying device in accordance with a preferred embodiment of the present invention.

### DESCRIPTION OF THE INVENTION

The aforementioned and other objects, characteristics and advantages of the present invention will become apparent with the detailed description of the preferred embodiments and the illustration of related drawings as follows.

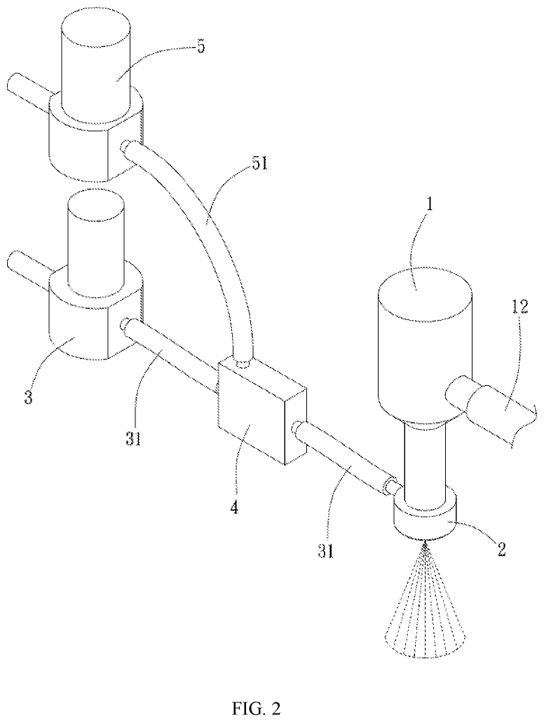

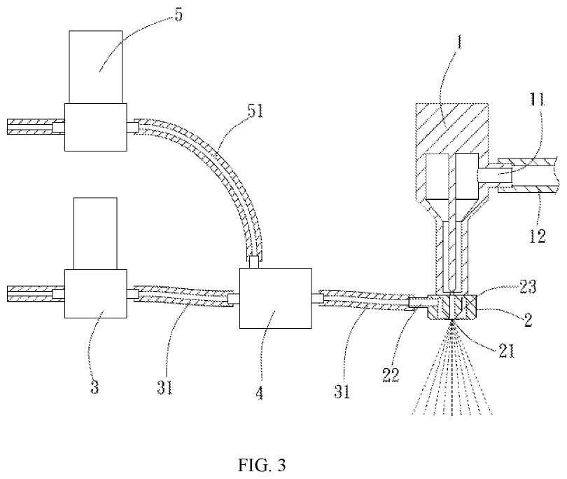

With reference to FIGS. 2 and 3 for an automatic cleaning and spraying device in accordance with a preferred embodiment of the present invention, the automatic cleaning and spraying device comprises: a spray valve 1, for controlling the output of a liquid material, and having a liquid inlet 11 disposed on a side of the spray valve 1 for connecting a liquid pipeline 12; an atomizer 2, coupled to an outlet of the spray valve 1, so that the liquid material in the spray valve 1 flows to the atomizer 2, and the atomizer 2 having a spray outlet 21 disposed at an end of the atomizer 2, for mixing a pressurized gas with a liquid material supplied by the spray valve 1 and spraying the mixed pressurized gas and liquid in a misty form; a pressurized gas valve 3, coupled to the atomizer 2 through a gas pipeline 31, for controlling the pressurized gas to be inputted to the atomizer 2, so that the pressurized gas is mixed with a liquid material in the atomizer 2; a mixer 4, installed in the gas pipeline between the atomizer 2 and the pressurized gas valve 3, for mixing a cleaning liquid with the pressurized gas and then sending the mixed cleaning liquid and pressurized gas to the atomizer 2; and a cleaning liquid valve 5, coupled to the mixer 4 through a cleaning liquid pipeline, for controlling the cleaning liquid to be inputted to the mixer 5, and then sending the mixed cleaning liquid and pressurized gas to the atomizer 2. The automatic cleaning and spraying device of the present invention is formed by the aforementioned components.

In FIGS. 2 and 3, the atomizer 2 has a gas inlet 22 disposed on a side of the atomizer 2 and coupled to the gas pipeline 31. The spray outlet 21 of the atomizer 2 includes a mixing chamber 23 therein, so that after the pressurized gas and the liquid material are mixed and inputted into the mixing chamber 23, the mixed pressurized gas and liquid material is sprayed in a misty form from the spray outlet 21 to the outside. The pressurized gas valve 3 and the cleaning liquid valve 5 are valves capable of switching their control by an instruction. For example, these valves may be electromagnetic valves used to achieve the automatic control effect.

In the first cleaning mode of the present invention, the pressurized gas valve 3 and the cleaning liquid valve 5 are controlled automatically to be opened synchronously by an instruction, and the spray valve 1 remains closed. The pressurized gas and the cleaning liquid are sent to the mixer 4 and mixed, and then the mixed pressurized gas and cleaning liquid are sprayed to the spray valve 1 and the atomizer 2 to dissolve and carry away the residue in the passage, and finally the residue is sprayed away from the spray outlet 21 to the outside. In the second cleaning mode, the pressurized gas valve 3 is closed, and only the cleaning liquid valve 5 is opened, and the spray valve 1 also remains closed. The cleaning liquid passes through the mixer 4 (without mixing with the gas) and flows through the spray valve 1 and the atomizer 2 to dissolve residue and flows the residue to the outside through the spray outlet 21 of the atomizer 2. Therefore, the automatic cleaning and spraying device of the present invention can achieve the automatic cleaning effect.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An automatic cleaning and spraying device, comprising: a spray valve, being a device for controlling the supply of a liquid material; an atomizer, combined with an outlet of the spray valve, and having a spray outlet disposed at an end of the atomizer for mixing a pressurized gas with the liquid material supplied by the spray valve and spraying the mixed pressurized gas and liquid material in a misty form; a pressurized gas valve, coupled to the atomizer through a gas pipeline, for controlling the pressurized gas to be outputted to the atomizer; a mixer, installed in a gas pipeline between the atomizer and the pressurized gas valve, for mixing a cleaning liquid with the pressurized gas and then sending the mixed cleaning liquid and pressurized gas to the atomizer; and a cleaning liquid valve, coupled to the mixer through a cleaning liquid pipeline, for controlling the cleaning liquid to be inputted to the mixer.

2. The automatic cleaning and spraying device of claim 1, wherein the spray valve has a liquid inlet coupled to a liquid pipeline; and the atomizer has a gas inlet coupled to the gas pipeline.

3. The automatic cleaning and spraying device of claim 2, wherein the atomizer has a mixing chamber formed inside the spray outlet, and the pressurized gas and the liquid material are mixed after entering into the mixing chamber, and the mixed pressurized gas and liquid material are sprayed in a misty form from the spray outlet.

4. The automatic cleaning and spraying device of claim 1, wherein the pressurized gas valve and the cleaning liquid valve are valves provided for switching a control by an instruction.

5. The automatic cleaning and spraying device of claim 3, wherein the pressurized gas valve and the cleaning liquid valve are valves provided for switching a control by an instruction.
